(19) United States
(12) Patent Application Publication
(10) Pub. No.: US 2002/0038355 A1
(43) Pub. Date: Mar. 28, 2002

(54) System and method for managing infrastructure and eviroment in a bulding

(76) Inventors: Scitt Mager, New york, NY (US); Jeffrey C. Friedman, New York, NY (US)

Correspondence Address: KILE GOEKJIAN LERNER & REED PLLC, THE EVENING STAR BUILDING, 1101 PENNSYLVANIA AVE, N.W., SUITE 800, WASHINGTON, DC, 20004, US

(21) Appl. No.: 09/960,995

(22) Filed: Sep. 25, 2001

Related U.S. Application Data
(63) Continuation of application No. 60/234,757, filed on Sep. 25, 2000.

(51) Int. Cl. G06F 15/16

(52) U.S. Cl. 709/217

(57) ABSTRACT

A system and method for managing the infrastructure and environment of a building and the provision of internal services in the building by providing a portal for a building accessible via the Internet having services associated with the portal based upon specific needs of the building. Orders for internal services are received from a user of the portal and the user is provided with status information for the orders. The portal is designed to suit the specific needs of a building.

### CROSS-REFERENCE TO RELATED APPLICATION

This application relates to and claims priority of Provisional Application serial No. 60/234,757 filed on Sep. 25, 2000, and entitled “System and Method for Managing the Infrastructure and Environment in a Building.”

### BACKGROUND OF THE INVENTION

### FIELD OF THE INVENTION

The present invention relates to system and method for managing the infrastructure and environment in a building. More particularly, the invention is directed to managing the infrastructure and environment in a building using the Internet to provide an integrated system and method for ordering and tracking internal infrastructure and environment-related services in a building.

The management of infrastructure and environment of a building is a complex and time-consuming activity. In a typical commercial building, various office personnel including office administrators often order services related to managing the infrastructure and environment of the building in which their office resides. In the context of the present invention, such services are referred to as internal services, examples of which include cleaning, equipment repair, and environmental control. The building manager typically takes responsibility for fulfilling such orders.

Unfortunately, the existing processes office personnel use for ordering internal services are inefficient. For example, office managers spend a great deal of valuable time on the phone arranging internal service orders with building managers. Office personnel often become frustrated in attempting to contact the building manager, and have no alternative but to leave a message on the building manager's voice mail regarding the order. Furthermore, interacting with numerous office personnel in a large building, who actually request the services, is a time consuming, inefficient, and cumbersome task for most building managers.

Existing processes for tracking the status of an order for internal services are also inefficient For example, the only way most office personnel have for tracking the status of such an order is to persistently call the building manager. This further decreases the efficiency of the building manager. For example, the building manager typically spends a great deal of valuable time on the phone responding to numerous calls from office personnel either requesting internal service orders or checking the status of previously ordered internal services. Accordingly, it would be desirable to provide a way to streamline the processes for ordering internal services in a building and for tracking orders placed for internal services in a building.

Recent advancements in the Internet have brought, via the World Wide Web (the “Web”), a potential to automate many of the manual processes executed daily by people in large commercial office buildings, such as building managers, office administrators, office personnel, and maintenance personnel, in the management of the buildings. In this, a portal is a Web “super-site” providing access to a variety of integrated services including Web searching, news, white and yellow pages directories, e-mail, discussion groups, online shopping and hyperlinks to other Web sites. A portal is the Web equivalent to the original integrated online services such as CompuServe and AOL. Unfortunately, portals in the prior art are not designed to suit the specific needs of managing the provision of internal services in a particular building.

Accordingly, it would be desirable to provide a system and method for managing the infrastructure and environment in a building, which streamline the processes of ordering and providing infrastructure and environment-related services in a building. In this, it would be highly desirable to provide successful integration of such processes with the Web, for example, by means of a portal for a building, which would fundamentally change the way offices utilize their resources and budget their time, resulting in highly efficient processes and substantial economic savings.

The difficulties, limitations and desires suggested in the preceding are not intended to be exhaustive, but rather are among many which demonstrate that prior art systems and methods for managing the infrastructure and environment in a building and for provision of internal services in a building win admit to worthwhile improvement.

### OBJECTS OF THE INVENTION

It is, therefore, a general object of the invention to provide a system and method for managing the infrastructure and environment in a building and the provision of internal services in a building, which streamline the processes of ordering and providing internal infrastructure and environment-related services in a building thereby obviating or minimizing difficulties of the type previously described.

It is another general object of the invention to provide a system and method for managing the infrastructure and environment in a building and the processes for providing internal infrastructure and environment-related services, which integrate the processes with the Web.

It is a specific object of the invention to provide a system and method for managing the infrastructure and environment in a building and the provision of internal services using a Web-based portal for a building, resulting in highly efficient processes and substantial economic savings.

It is another specific object of the invention to provide a system and method for managing the infrastructure and environment and the provision of internal services in a building network system.

It is yet another specific object of the invention to provide a system and method for managing the infrastructure and environment in a building and the provision of internal services which automatically differentiate user roles in a building.

It is yet another specific object of the invention to provide a building network system for managing the infrastructure and environment in a building and the provision of internal services through a portal designed to suit the specific needs of the building.

It is yet another specific object of the invention to provide a process of using a building network system to create a portal designed to suit the specific needs of a building for managing the infrastructure and environment in the building and the provision of internal services.

It is yet another specific object of the invention to provide a system and method for managing the infrastructure and environment in a building and the provision of internal services by using a Web-based portal to order the internal infrastructure and environment-related services for the building.

It is another specific object of the invention to provide a system and method for managing the infrastructure and environment in a building and the provision of internal services which track and monitor internal service orders made through a Web-based portal.

It is another specific object of the invention to provide a system and method for managing the infrastructure and environment in a building and the provision of internal services which improve accountability of the building manager by tracking the building manager's response to an internal service order.

It is yet another specific object of the invention to provide a system and method for managing the infrastructure and environment in a building and the provision of internal services which produce savings in time for office personnel to place and track internal service orders, and for the building manager to respond to requests for internal services by office personnel.

It is yet another specific object of the invention to provide a system and method for managing the infrastructure and environment in a building and the provision of internal services which utilize a computer connected with the Internet.

It is another specific object of the invention to provide a system and method for managing the infrastructure and environment in a building and the provision of internal services with a computer system accessible via the Internet

### SUMMARY OF THE INVENTION

To achieve at least some of the foregoing objects, the invention provides a method for managing the infrastructure and environment of a building and the provision of internal services in the building by providing a portal for a building accessible via the Internet. At least one internal service of interest to the building is associated with the portal for the building based upon specific needs of the building. Orders for one or more internal services are received from a user of the portal and the user is provided with status information of the orders.

A home page for each user of the portal is provided and each user is uniquely identified and has a specific user role with respect to the portal for a building. The home page may actually consist of several pages of information and links. The user of the portal is provided with status information of the orders by setting a request status for each of the orders from one or more of pending, completed, delayed, backorder, expected delivery date, out-of-stock, unavailable, and denied and, on a selective basis, providing the user access to view the request status for each of the orders.

Order parameters for each user are specified and a determination of whether or not approval is necessary is made after receiving the orders from a user based upon the specified order parameters. A user is notified whether or not the received orders have been approved.

In a preferred embodiment of the present invention, the building is a building network.

A user is provided with access to an anonymous user home page and a determination is made whether the user is one of a building user and a vendor user. Data input by the user with respect to a user profile are received and the data are processed to create one of a building user home page and a vendor user home page. Data input with respect to a building manager profile are received and a building manager home page accessible via the portal is created. The building manager home page displays the one or more internal service and manages the orders from a user of the portal. A link for selecting the building manager home page is provided on the building user home page and means for requesting the internal service are provided on the business manager home page. Information about the orders is provided through the business manager home page.

A system for managing the infrastructure and environment of a building and the provision of internal services in the building is provided having at least one server accessible via a communications network. The server provides a portal for a building accessible by one or more user via the communications network and has at least one internal service of interest to the building associated with the portal for the building. The internal service is determined based upon specific needs of the building. The server further includes a receiving module operable to receive orders for the at least one internal service from the one or more user of the portal; a transmitting module operable to provide the one or more user of the portal with status information of the orders; and a database operable to store a user profile for each of the one or more user of the portal.

The portal includes a home page for each of the one or more user of the portal with each user being uniquely identified and having a specific user role with respect to the portal for a building; and a building manager home page displaying the internal service and managing the orders for the internal service.

In a preferred embodiment of the present invention, the building is a building network and the communications network is the Internet.

### DRAWINGS

Other objects and advantages of the present invention will become apparent from the following detailed description of preferred embodiments thereof taken in conjunction with the accompanying drawings, wherein:

FIG. 1 shows schematically a building network system for managing the infrastructure and environment in a building and the provision of internal services according to a preferred embodiment of the present invention;

FIG. 2A-C are schematic representations of a process for creating a portal for managing the infrastructure and environment in a building and the provision of internal services according to a preferred embodiment of the present invention;

FIG. 3 is a schematic depiction of a process for accessing a user home page according to a preferred embodiment of the present invention; and

FIG. 4 shows a schematic representation of a process for managing the infrastructure and environment in a building and the provision of internal services according to a preferred embodiment of the present invention.

### DETAILED DESCRIPTION

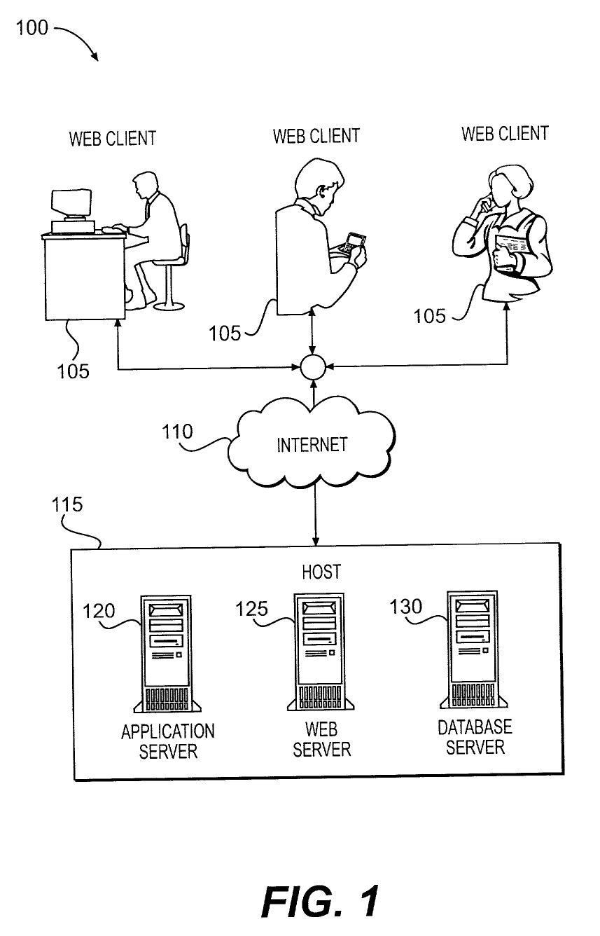

Referring to FIG. 1, a building network system 100, according to a preferred embodiment of the present invention, includes one or more Web clients 105, the Internet 110, and a host 115. Web clients 105 include any conventional system for accessing the Internet, such as a personal computer with a Web browser, personal digital assistant (PDA) including a Web browser, and cellular telephone further including a wireless application protocol (WAP) based browser.

Host 115 further includes elements commonly employed by most internet service providers (ISPs), such as an application server 120, Web server 125, and database server 130. Host 115 further provides a Web-based portal.

As used herein, a portal is a Web “super-site” providing access to a variety of integrated services including, for example, Web searching, news, white and yellow pages directories, e-mail, discussion groups, online shopping and hyperlinks to other Web sites. A portal is the Web equivalent of the original integrated online services such as CompuServe and AOL. Although the term portal initially referred to general-purpose Web sites, it now commonly refers to vertical market Web sites offering related services to a particular industry such as banking, insurance or computers. In this sense, the present invention relates to a portal for a building.

Each user of system 100 falls into a predefined role. Each role provides specific functionality as described below. User roles include, for example, super administrator, building administrator or manager, tenant administrator, office administrator, office user, vendor administrator, vendor user, and anonymous user.

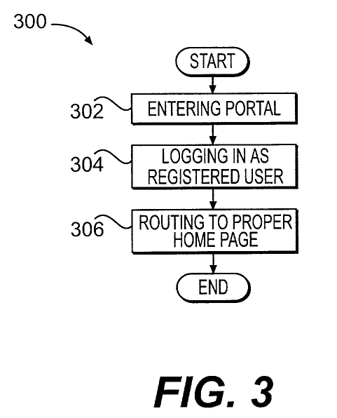

By default, host 115 is configured to allow access of a user corresponding to the anonymous user role through a Web client 105 via the Internet 110. The anonymous user role allows public access to the portal. Host 115 further provides a home page for an anonymous user to access (refer to FIG. 3).

By default, host 115 is configured to allow access of a user corresponding to the super administrator role through a Web client 105 via the Internet 110. In particular, database server 130 contains a user name and password for a super administrator. Host 115 provides a home page for a super administrator to access (refer again to FIG. 3).

Through their home page, a super administrator can perform any function of the system 100 and is responsible for managing all aspects of the system 100. This includes the management of certain aspects of all other users of the system 100. When creating a new user, the super administrator enters data into the database server 130 including the following data elements:

E-mail address (doubles as a user name)

Temporary password (user is asked to pick a new password upon first login to the system)

User role

Password hint

First name

Middle Name/Initial

Last name

Company

Department

Title

E-mail

Home Phone

Work Phone

Mobile Phone

Pager

Fax

Address 1

Address 2

City

State

Zip

Gender

Birth date

Marital Status

Number of children

Income bracket

Education level

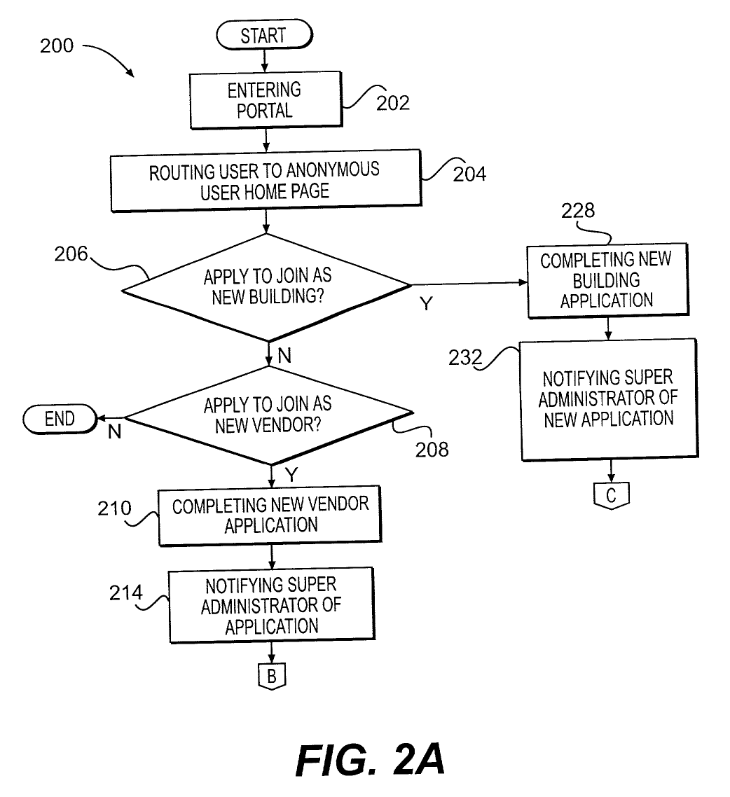

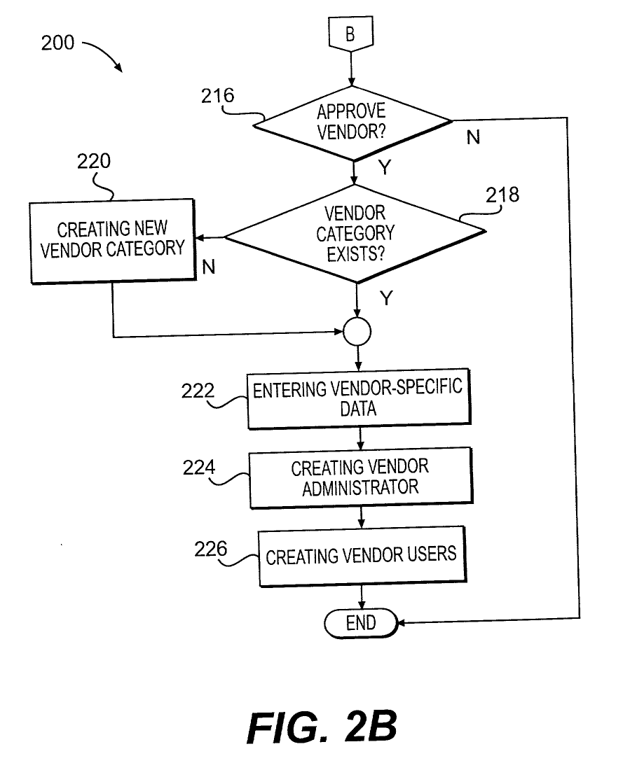

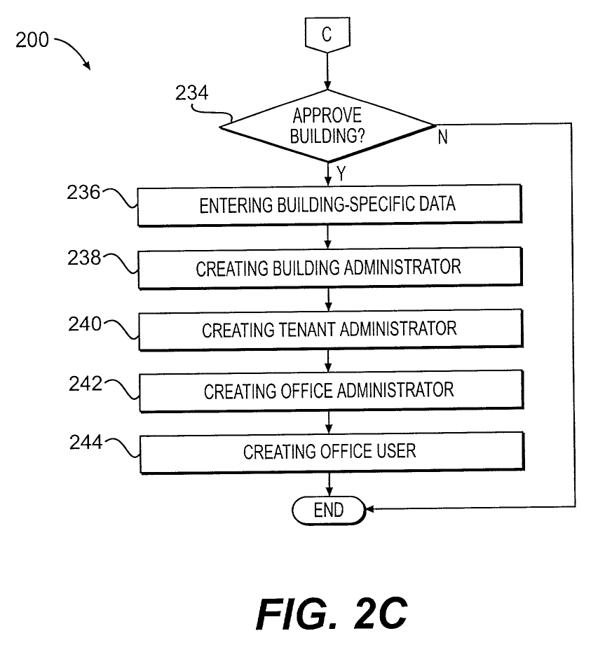

Referring to FIGS. 2 A-C, a process 200 for creating a portal for a building includes:

Step 202: Entering Portal (FIG. 2A)

In step 202 (note FIG. 2A), a user enters the portal residing on host 115 through a Web client 105 and the Internet 110. In particular, a user accesses the portal by entering the uniform resource locator (URL) of the portal into a browser on their Web client 105. By default, host 115 assigns the anonymous user role to the user.

For reasons of simplicity, this step refers to the term portal although the state of the portal is not yet fully built out.

Step 204: Routing User to Anonymous User Home Page

In step 204, the user is routed to an anonymous user home page residing on the host 115 via a hyperlink on the portal.

Step 206: Apply to Join as New Building?

In step 206, the anonymous user decides whether to join as a new building. If yes, then the process 200 proceeds to step 228; if no, then the process 200 proceeds to step 208.

Step 208: Apply to Join as New Vendor?

In step 208, the anonymous user decides whether to join as a new vendor. If yes, then the process 200 proceeds to step 210; if no, then the process 200 terminates.

Step 210: Completing New Vendor Application

In step 210, the anonymous user completes a new vendor application by entering required data into the fields of an online new vendor application form. The anonymous user enters data into the database server 130 including the following data elements:

Contact Name

Contact Information

Vendor name

Vendor Description

Vendor category

The database server 130 associates a unique identification (ID) code with the data.

Step 214: Notifying Super Administrator of Application

In step 214, the process 200 notifies the super administrator of the application for a new vendor via an e-mail message containing a hyperlink to the portal and the ID code assigned in step 210. The super administrator logs onto the portal as described in connection with FIG. 3 below. From their home page, the super administrator enters the ID code into a text field and submits the ID code to the host 115. The host 115 then serves a Web page containing the new vendor application data entered in step 210.

Step 216: Approve Vendor? (FIG. 2B)

In step 216 (note FIG. 2B), the super administrator reviews the new vendor application data and decides whether to approve the new vendor. If yes, then the process 200 proceeds to step 218; otherwise, the process 200 terminates. If approved, the super administrator will contact the vendor representative identified in step 210 directly via phone in order to work out any specific details associated with the approval.

Step 218: Vendor Category Exists?

In step 218, the super administrator determines if a vendor category exists for the new vendor. In particular, the super administrator searches the database server 130 to determine if a record containing the appropriate vendor category exists. Vendor categories include those internal services used by users of office buildings, such as cleaning, equipment repair, environmental control, and the like. If no, then the process 200 proceeds to step 220; if yes, then the process 200 proceeds to step 222.

Step 220: Creating New Vendor Category

In step 220, the super administrator creates a new vendor category in the database server 130 corresponding to the new vendor. In particular, the super administrator can add, edit, and remove categories of vendors in the database server 130. All vendors will fall into specific categories (e.g., cleaning service, equipment repair, environmental control, among others). Vendor categories affect the way vendors are depicted on-screen and help determine which vendors are appropriate for which buildings. When adding a vendor category, the super administrator enters data into the database server 130 including the following data elements:

Category Name

Category Description

Step 222: Entering Vendor-specific Data

In step 222, the super administrator enters data into the database server 130 including the following vendor-specific data elements:

Name

Vendor Category

Short description

Long description

Address 1

Address 2

City

State

Zip

Main phone number

Primary contact

Primary contact phone number

Optionally, the super administrator can enter data into the database server 130 including the following data elements:

Primary contact e-mail

Primary contact fax

Secondary contact

Secondary contact phone

Secondary contact e-mail

Secondary contact fax

Website URL

Logo

Global specials

Tenant specials

Union status

Step 224: Creating Vendor Administrator

In step 224, the super administrator configures the host 115 to allow access of a user corresponding to the vendor administrator role through a Web client 105 via the Internet 110. In particular, the super administrator creates an e-mail account for a vendor administrator on host 115. The super administrator then stores a user name and temporary password in the database server 130 corresponding to the vendor administrator. The super administrator then sends an e-mail message to the e-mail account of the vendor administrator. The e-mail message contains the temporary password, a hyperlink to the portal, and directions for accessing the new user's home page (refer to FIG. 3).

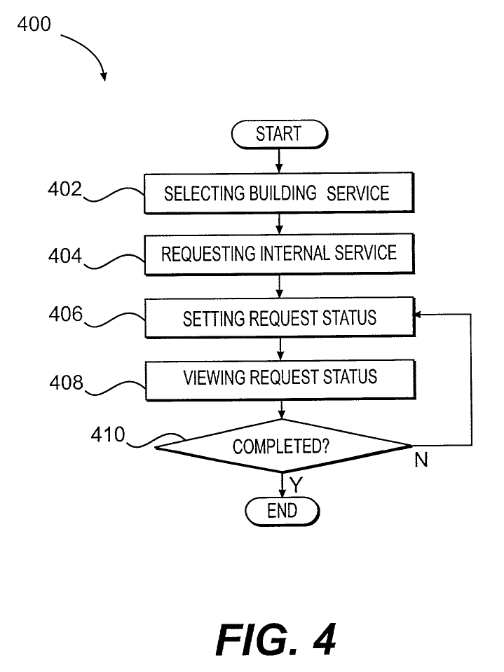

Through their home page, a vendor administrator presents products and services to users of system 100 and manages orders of products and services requested by users of the system 100 as described in connection with FIG. 4 below. In particular, a vendor administrator typically views pending orders, sets the status of orders, and downloads order information in a spreadsheet format. The system 100 allows a vendor administrator to group orders by tenant, building, date, order status, or any combination thereof.

Step 226: Creating Vendor Users

In step 226, the super administrator configures the host 115 to allow access of a user corresponding to the vendor user role through a Web client 105 via the Internet 110. In particular, the super administrator creates an e-mail account for a vendor user on the host 115. The super administrator then stores a user name and temporary password in the database server 130 corresponding to the vendor user. The super administrator then sends an e-mail message to the e-mail account of the vendor user. The e-mail message contains the temporary password, a hyperlink to the portal, and directions for accessing the new user's home page (refer again to FIG. 3).

Alternatively, a vendor administrator configures the host 115 to allow access of a user corresponding to the vendor user role through a Web client 105 via the Internet 110. In particular, the super administrator creates an e-mail account for a vendor user on the host 115. The vendor administrator then stores a user name and temporary password in the database server 130 corresponding to the vendor user. The vendor administrator then sends an e-mail message to the e-mail account of the vendor user. The e-mail message contains the temporary password, a hyperlink to the portal, and directions for accessing the new user's home page

Through their home page, a vendor user assists the vendor administrator in managing orders requested by users of the system 100. Similar to FIG. 4, the vendor user and/or vendor administrator has the capability to view pending orders, set order status, and download order information in a spreadsheet format. The configuration of host 115 allows a vendor user to group orders by tenant, building, date, order status, or any combination thereof.

Step 228: Completing New Building Application (FIG. 2A)

In step 228 (note again FIG. 2A), the anonymous user completes a new building application by entering required data into the fields of an online new building application form. An anonymous user requesting to join as a new building would likely be a representative of a building management organization (BMO) or a building owner.

The anonymous user enters data into the database server 130 including the following data elements:

Name

Contact Information

Building name

Building address

Database server 130 associates a unique ID code with the data.

Step 232: Notify Super Administrator of Application

In step 232, the process 200 notifies the super administrator of the application for a new building via an e-mail message containing a hyperlink to the portal and the previously assigned ID code assigned in step 228. The super administrator logs onto the portal as described in connection with FIG. 3. From their home page, the super administrator enters the ID code into a text field and submits the ID code to the host 115. The host 115 then serves a Web page containing the new building application data entered in step 228.

Step 234: Approve Building (FIG. 2C)

In step 234 (note FIG. 2C), the super administrator decides whether to approve the new building. If yes, then the process 200 proceeds to step 236; if no, the process 200 terminates. If approved, the super administrator will contact the building representative identified in step 228 directly via a phone in order to work out any specific details associated with the approval.

Step 236: Entering Building-specific Data

In step 236, the super administrator enters data into the database server 130 including the following data elements:

Address 1

Address 2

City

State

Zip

Tenants

Company Name

Description

Business Type

In particular, a tenant is an organization that rents space within a building.

Step 238: Creating Building Administrator

In step 238, the super administrator configures the host 115 to allow access of a user corresponding to the building administrator role through a Web client 105 via the Internet 110. In particular, the super administrator creates an e-mail account for a building administrator on the host 115. The super administrator then stores a user name and temporary password in the database server 130 corresponding to the building administrator. The super administrator then sends an e-mail message to the e-mail account of the building administrator. The e-mail message contains the temporary password, a hyperlink to the portal, and directions for accessing the new user's home page (refer to FIG. 3).

Through their home page, a building administrator enters data into the database server 130 including the following building-related data elements:

Address

Name (of the building)

Owner

Photo

Square Feet

Floors

Elevators

Date built

Parking

Hours of operation

Freight hours

Delivery hours

Delivery rules

Rules+Regulations

Work Rules

Work Regulations

Union status

Managing Agent

Name

Address

Phone/Fax

E-mail

Contact

Staff

Building Manager

Assistant Building Manager

Concierge

Engineers

Porters

Fire Safety Director(s)

Leasing Agent

Name

Address

Phone/Fax

E-mail

Contact

Cleaning Contractor

Name

Address

Phone/Fax

E-mail

Contact

Has parking?

Can use roof?

Loading dock

Fire contact

EMS Contact

Police contact

Type of security system

Management company

Available space

Each available space entry must specify the floor number, square footage, and a description of the space.

Vendors

The building administrator selects appropriate vendors from a global collection of vendors in the database server 130 and makes them available to the users in a particular building. By default, all vendors win be available to all users in the building.

A super administrator repeats this step as needed to create additional building administrators.

Step 240: Creating Tenant Administrator

In step 240, the building administrator configures the host 115 to allow access of a user corresponding to the tenant administrator role through a Web client 105 via the Internet 110. In particular, the building administrator creates an e-mail account for a tenant administrator on the host 115. The building administrator then stores a user name and temporary password in the database server 130 corresponding to the tenant administrator. The building administrator then sends an e-mail message to the e-mail account of the tenant administrator. The e-mail message contains the temporary password, a hyperlink to the portal, and directions for accessing the new user's home page (refer to FIG. 3).

Since tenants may span multiple buildings, this role is reserved for a tenant employee who is capable of making corporate-wide (not office-wide) decisions about internal services, vendor relationships, etc.

A building administrator repeats this step as needed to create additional tenant administrators.

Step 242: Creating Office Administrators

In step 242, the tenant administrator configures the host 115 to allow access of users corresponding to the office administrator(s) role through a Web client 105 via the Internet 110. In particular, the tenant administrator creates e-mail accounts for office administrators on the host 115. The tenant administrator then stores a user name and temporary password in the database server 130 corresponding to each office administrator. The tenant administrator then sends an e-mail message to the e-mail account of each office administrator. The e-mail message contains the temporary password, a hyperlink to the portal, and directions for accessing the new user's home page (refer to FIG. 3).

Through their home page, an office administrator enters data corresponding to their particular office into the database server 130, including the following data elements:

Contact Information

Facility Manager Contact Information

Purchasing Manager Contact Information

Number of employees

Internet access speed

Number of computers

Fire Warden

Location of office within building

Although a building administrator or tenant administrator can also accomplish this task, it is likely that an office administrator will be in the best position to answer these office-specific questions.

Through their home page, a tenant administrator defines a set of rules for ordering internal services for each office administrator created and stores these rules in the database server 130. For each office administrator created and each vendor the building administrator made available to the building in step 238, the tenant administrator enters data into the database server 130 including the following data elements:

Include hyperlink to vendor's home page on office administrator's home page?

By default, hyperlinks to all of the vendors made available to a particular building will be included on each office administrator's home page.

Maximum purchase amount the office administrator can make without approval.

By default, all office administrators will have the capability to make purchases without approval up to a predetermined amount.

Vendor-specific purchasing rules.

For example, a specific internal service may only be made available to users after 6:00 PM on weekdays.

Automatic order completion confirmation?

The tenant administrator determines which vendors require order completion confirmation. For equipment repair, or certain cleaning orders, or other services where the tenant administrator's manual confirmation is not necessary, the tenant administrator selects automatic order completion confirmation.

From their home page, an office administrator periodically views a list of all pending orders generated from users within their particular office. The office administrator views orders based on status (pending, completed, delayed, backordered, out-of-stock, unavailable), date of the order, vendor, or the user generating the order. The office administrator can then generate a printable report or download the data in spreadsheet format for further processing in Excel® or a similar application. Refer to FIG. 4.

A tenant administrator repeats this step as needed to create additional office administrators.

Step 244: Creating Office Users

In step 244, the office administrator configures the host 115 to allow access of a user corresponding to the office user role through a Web client 105 via the Internet 110. In particular, the office administrator creates an e-mail account for an office user on the host 115. The office administrator then stores a user name and temporary password in the database server 130 corresponding to the office user. The office administrator then sends an e-mail message to the e-mail account of the office user. The e-mail message contains the temporary password, a hyperlink to the portal, and directions for accessing the new user's home page (refer to FIG. 3).

Through their home page, the office administrator enters data into the database server 130 including the following data elements related to the new office user:

E-mail address

First name

Last name

ID (e.g., birthday, or last 4 digits of social security number)

Through their home page, an office administrator defines a set of rules for the office user created and stores these rules in the database server 130. For the office user created and each vendor the tenant administrator made available to the office administrator, the office administrator enters data into the database server 130 including the following data elements:

Include hyperlink to vendor's home page on office user's home page?

By default, hyperlinks to all of the vendors made available to a particular building will be included on the office user's home page.

Maximum purchase amount the office user can make without approval.

By default, the office user will have the capability to make purchases without approval up to a predetermined amount.

Vendor-specific purchasing rules.

For example, a specific service may only be made available to users after 6:00 PM on weekdays.

To further facilitate the process of creating purchasing rules for an office user, the system 100 allows an office administrator to create purchasing classes and assign an office user to a specific purchasing class. In particular, the host 115 allows an office administrator to create a new purchasing class and assign a specific set of purchasing rules to that purchasing class. For example, one purchasing class may contain a rule that allows the ordering of cleaning service only after 6:00 PM, whereas another purchasing class may contain a rule that allows the ordering of cleaning service at any time. This information is stored in the database server 130.

An office administrator repeats this step as needed to create additional office users.

Easy as this may be, it would still be tedious for an office administrator to set up an office of 1,000 employees using this method. Therefore, the system 100 allows an office administrator to automatically create a large group of new users by storing in the database server 130 a file containing a list of e-mail addresses. This data is easily accessible since many offices already have a list of employees in spreadsheet or database format. The database server 130 automatically sends an e-mail message to each e-mail address listed. Each e-mail message contains a unique temporary password and a hyperlink to the portal.

Through their home page, an office user orders internal services from any vendor made available to them. In addition, an office user periodically views a list of all pending orders to determine when a particular service has been fulfilled or a product has been delivered (refer to FIG. 4).

Step 246: Creating Building Manager

In step 246, the building administrator configures the host 115 to allow access of a specific type of user referred to as a building manager through a Web client 105 via Internet 110. In particular, the building administrator creates a user name and password for a building manager, stores the user name and password in the database server 130, and associates the user name and password with the relevant building-related data residing in the database server 130.

The host 115 provides a building manager with a home page for presenting internal services and managing orders of internal services requested by users of system 100 as described below with reference to FIG. 4. In particular, a building manager typically views pending orders, sets the status of orders (pending, completed, delayed, backordered, out-of-stock, unavailable), and downloads order information in, for example, a spreadsheet format. The configuration of the host 115 allows a building manager to group orders by tenant, vendor, date, order status, or any combination thereof. This is not limited to orders made to the building manager, but all orders and their status made to vendors made by building users or vendor users and/or vendor administrators which service within a particular building network

Referring to FIG. 3, a process 300 for accessing a user home page comprises the following steps.

Step 302: Entering Portal

In step 302, a user enters a portal residing on the host 115 through a Web client 105 and the Internet 110. In particular, a user accesses the portal by entering the uniform resource locator (URL) of the portal into the browser on their Web client 105.

Step 304: Logging in as Registered User

In step 304, the process 300 allows a user to register using a predefined user name and password. In particular, the user enters a user name and password into a login Web page on the portal. The host 115 authenticates the user name and password. In the event that a new user attempts to register with a temporary password, host 115 prompts the new user to pick a new password and fill out the remainder of his or her profile.

Step 306: Routine to Proper Home Page

In step 306, the process 300 routes the user to the home page corresponding to the user name of the user entered in step 304. The host 115 automatically creates a new user home page for a new user. A user home page may consist of several pages customized specifically for the individual user.

For example, a user having a role corresponding to an office user would enter a user name and a corresponding password into the appropriate fields within a Web page on the Web client 105. The host 115 then routes the Web browser on the Web client 105 to the home page of the office user.

Referring to FIG. 4, the following describes a process for managing the infrastructure and environment in a building and the provision of internal services. A user executes the process 400 from their home page residing on the portal. FIG. 3 depicts the process 300 for accessing a user home page. Any user of the system can order services as described by process 400. User having authority to view the status of a request can do so via their home page at any time during the process 400. For example, an office administrator can view the status of a request initiated by an office user. Status levels include, for example, pending, approved, denied, backordered, expected delivery date, and completed.

The process 400 comprises the following steps.

Step 402: Selecting Building Services

In step 402, a user selects a hyperlink to a building services located on the user's home page. The host 115 then links the user's Web browser to the building service vendors inclusive of the building manager within the portal containing a list of internal services offered by the building manager.

Step 404: Requesting Internal Service

In step 404, the user requests an internal service from the building manager by entering the details of the request (e g., overhead light is out in office 3125, air conditioning is malfunctioning on floor 32, window is broken in office 4531, etc.) into a free-form text field located on the that portion of the user's home page, then clicking the option to submit the request. The host 115 stores the request and date of the request in the database server 130. The host 115 then makes the request and date of the request available to the building manager through the building manager's home page.

Alternatively, the building manager may order building services through their home page by following the steps outlined above as a user. This enables the building manager to keep all records of all orders made to the building within the building network.

Alternatively, any user may create an order for building services that can be viewed and managed by the building manager user.

Step 406: Setting Request Status

In step 406, the building manager a sets or modifies the status of the request via the building manager's home page. Status levels include pending, completed, delayed, backorder, expected delivery date, out-of-stock, unavailable, and denial of request.

Alternatively, a vendor administrator or vendor sets or modifies the status of the request via the respective vendor administrator or vendor user home page. Status levels include pending, completed, delayed, backorder, expected delivery date, out-of-stock, unavailable, and denial of request. In the event a vendor user or vendor administrator receives, processes, updates or completes an order, or in other words takes action on an order placed by a user, the building manager may be notified of the order and be given the opportunity to view the order and its status from building manager's home page.

Step 408: Viewing Request Status

In step 408, any user having authority to view the status of the request does so via the user's home page. For example, both the requesting user and the building manager periodically view the status of the request. This permission may include specific vendors that use the building network and/or service the building.

Step 410: Completed

In step 410, the requesting user determines if the building manager provided the requested internal service. If yes, then process 400 terminates; if no, then process 400 returns to step 406. The process 400 terminates after step 410.

Although the above description of the present invention is directed to a network provided in a building, it can be appreciated that the present invention could also be applied to any type of facility such as a hotel, university campus, government complex, airport, shipping port, factory, amusement park, shopping mall or cruise ship. Further, the present invention could also be applied to a geographical area such as a park containing dispersed facilities, and a body of water whereon ships are dispersed.

Summary of Major Advantages of the Invention

After reading and understanding the foregoing description of preferred embodiments of the invention, in conjunction with the illustrative drawings, it will be appreciated that several distinct advantages of the subject system and method for managing the infrastructure and environment of a building and the provision of internal services in a building are obtained.

One advantage of the present invention is a portal designed to suit the specific needs of a particular building. The portal provides a convenient, integrated location for office personnel to efficiently place orders for internal services. Such a system and method would provide owners of buildings with a new means for attracting new tenants to the building. In particular, the efficiency of an automated system and method for managing the infrastructure and environment of a building and the provision of internal services in a building would attract tenants by saving their office personnel's time in ordering internal services and having a positive affect on their bottom-line labor costs.

In addition, an automated system and method for managing the infrastructure and environment of a building and the provision of internal services in a building would complement a portal through which additional commercial products and services including food, office supplies, limousine service, messenger service, and upgrade office cleaning service are promoted and sold to tenants within the building.

Another advantage of the present invention is a way to automatically differentiate user roles in a building.

Yet another advantage of the present invention is that it saves the user time, money, and effort by reducing time spent in ordering and monitoring internal services that are typically required by office personnel in an office building.

In accordance with the foregoing, the present invention provides a system and method for managing the infrastructure and environment of a building and the provision of internal services in a building. The present invention offers online, one-stop shopping for various internal services to various users associated with a building through a portal.

A building is a physical location run by a building management organization (BMO). One building houses many tenants, each tenant occupying one or more offices, and offers internal services of many vendors.

A portal is a Web “super-site” providing access to a variety of integrated services including, for example, Web searching, news, white and yellow pages directories, e-mail, discussion groups, online shopping and hyperlinks to other Web sites. A portal is the Web equivalent of the original integrated online services such as CompuServe and AOL. Although the term portal initially referred to general-purpose Web sites, it now commonly refers to vertical market Web sites offering related services to a particular industry such as banking, insurance or computers. In this sense, the present invention relates to a portal for a building.

A first aspect of the present invention is a building network system for managing the infrastructure and environment of a building and the provision of internal services in a building through a portal designed to suit the specific needs of the building.

A second aspect of the present invention is a process of using the building network system to create a portal designed to suit the specific needs of a building for managing the infrastructure and environment of a building and the provision of internal services in a building.

A third aspect of the present invention is a process of using the portal to manage the infrastructure and environment of a building and order internal services in the building.

A fourth aspect of the present invention is a process of tracking orders made through the portal.

A fifth aspect of the present invention is carrying out the processes according to the present invention in a computer.

A sixth aspect of the present invention is a computer system capable of carrying out the processes according to the present invention.

In describing the invention, reference has been made to preferred embodiments and illustrative advantages of the invention. Those skilled in the art, however, and familiar with the instant disclosure of the subject invention, may recognize additions, deletions, modifications, substitutions and other changes that fall within the purview of the subject invention.

What is claimed:

1. A method for managing the infrastructure and environment of a building and the provision of internal services in the building, the method comprising the steps of:
providing a portal for a building accessible via the Internet;
associating at least one internal service of interest to the building with said portal for the building, said at least one internal service being determined based upon specific needs of the building;
receiving orders for said at least one internal service from a user of said portal;
providing the user of said portal with status information of said orders.

2. A method for managing the infrastructure and environment of a building and the provision of internal services in the building as defined in claim 1, wherein
said step of providing a portal for a building includes
the step of providing a home page for each user of said portal for a building, said each user being uniquely identified and having a specific user role with respect to said portal for a building.

3. A method for managing the infrastructure and environment of a building and the provision of internal services in the building as defined in claim 1, wherein
said step of providing the user of said portal with status information includes
the step of setting a request status for each of said orders, said request status being one or more of pending, completed, delayed, backorder, expected delivery date, out-of-stock, unavailable, and denied; and
on a selective basis, providing the user access to view said request status for each of said orders.

4. A method for managing the infrastructure and environment of a building and the provision of internal services in the building as defined in claim 1, further comprising the steps of
specifying order parameters for each user;
determining whether or not approval is necessary after receiving orders for said at least one internal service from a user; said determination being made based upon said specified order parameters;
notifying a user whether or not said received orders have been approved.

5. A method for managing the infrastructure and environment of a building and the provision of internal services in the building as defined in claim 1, wherein
said building is a building network.

6. A method for managing the infrastructure and environment of a building and the provision of internal services in the building as defined in claim 1, wherein
said step of providing a portal includes the steps of
providing a user with access to an anonymous user home page;
determining whether said user is one of a building user and a vendor user;
receiving data input by said user with respect to a user profile;
processing said data to create one of a building user home page and a vendor user home page.

7. A method for managing the infrastructure and environment of a building and the provision of internal services in the building as defined in claim 6, wherein
said step of associating at least one internal service includes
the step of receiving data input with respect to a building manager profile and creating a building manager home page accessible via said portal,
wherein said building manager home page displays said at least one internal service and manages said orders from a user of said portal.

8. A method for managing the infrastructure and environment of a building and the provision of internal services in the building as defined in claim 7, wherein
said step of receiving orders includes the steps of
providing on said building user home page a link for selecting said building manager home page;
providing on said building manager home page means for requesting said at least one internal service;
providing through said building manager home page information about said orders.

9. A system for managing the infrastructure and environment of a building and the provision of internal services in the building, the system comprising:
at least one server accessible via a communications network, said at least one server providing a portal for a building accessible by one or more user via said communications network and having at least one internal service of interest to the building associated with said portal for the building, said at least one internal service being determined based upon specific needs of the building;
said server further including
a receiving module operable to receive orders for said at least one internal service from said one or more user of said portal;
a transmitting module operable to provide said one or more user of said portal with status information of said orders; and
a database operable to store a user profile for each of said one or more user of said portal.

10. A system for managing the infrastructure and environment of a building and the provision of internal services in the building as defined in claim 9, wherein
said portal for a building includes
a home page for each of said one or more user of said portal for a building; said each user being uniquely identified and having a specific user role with respect to said portal for a building; and
a building manager home page displaying said at least one internal service and managing said orders for said at least one internal service.

11. A system for managing the infrastructure and environment of a building and the provision of internal services in the building as defined in claim 9, wherein
said building is a building network and said communications network is the Internet.
